(19) United States
(12) Patent Application Publication
(10) Pub. No.: US 2010/0088384 A1
(43) Pub. Date: Apr. 8, 2010

(54) AUTOMATED DIGITAL MATCHING OF MESSAGES

(75) Inventors: Alex Wilkinson, Woking (GB); Gary Brown, Hitchin (GB); Stephen Ross-Talbot, Henfield (GB); Michael Paull, Glandford (GB)

Correspondence Address: Workman Nydegger;1000 Eagle Gate Tower, 60 East South Temple, Salt Lake City, UT, 84111, US

(73) Assignee: Hat Trick Softward Limited, London (GB)

(21) Appl. No.: 12/598,299

(22) PCT Filed: Oct. 29, 2008
(86) PCT No.: PCT/GB2008/003688

§ 371 Date: Nov. 25, 2009

Related U.S. Application Data
(60) Provisional application No. 60/984,641, filed on Nov. 1, 2007.

(51) Int. Cl. G06F 15/16; G06F 15/173; G06F 21/00

(52) U.S. Cl. 709/206; 709/224; 709/230; 726/12

(57) ABSTRACT

A method and system of mediating an exchange of a series of digital messages between parties to ensure compliance with a predetermined messaging protocol associated with a transaction process. The mediation is achieved via an intelligent gateway located between an internal and an external communication network and comprises a component for monitoring messages passing through the gateway and determining whether the messages comply with or deviate from the predetermined messaging protocol, which may be coded in a global description language. The monitor may act passively and provide a notification of the degree of compliance or may actively block non-compliant messages. A mechanism is provided for replaying and fixing non-compliant messages. A system comprising several intelligent gateways includes a router for routing messages to a particular intelligent gateway according to destination. Information about the messages and their compliance can be tracked and sent to a central correlation unit for reconstituting a global picture of the transaction.

### FIELD OF THE INVENTION

The present invention relates to the intelligent monitoring of gateways between communications networks and particularly the compliance of transmitted messages with a predetermined messaging protocol.

### BACKGROUND TO THE INVENTION

To the outside observer, the trading room in a wholesale financial services company is a vast cathedral of enormous complexity. To an informed observer it is a well ordered capability organised by areas of market focus.

One of the most rapidly expanding areas of market focus is the Over-The-Counter derivatives market or “OTC derivatives trading”. This area transacts highly complex and long-lived trading products in a variety of different forms. Each transaction has a minimum of two counterparties—a buyer and a seller—and each party needs to “match” their understanding of the rights and obligations of each trade with the other once the trade has been executed.

Historically this post execution matching of transactions has been a manual process. Rapidly increasing transaction volumes and the introduction of progressively more complex transactional structures now requires these manual processes to be replaced with automated systems. This is particularly evident in the OTC credit derivatives market, where manual processes have been overwhelmed.

The inability of manual processes to maintain pace with the expansion of transaction volumes reached crisis levels in 2005, when the number of unsigned confirmations was being measured in terms of hundreds of thousands of transactions, with the problem compounding at a rate of over 15,000 new trades per day. The problem became sufficiently acute as to oblige the industry body, ISDA, to introduce a new measure for unconfirmed transactions. This measure expressed the number of unconfirmed trades in terms of “units of days worth of business”. This is determined by dividing the number of outstanding confirmations by the daily volume of new trades. By January 2006 this measure had exceeded 23 days amongst the leading market participants.

The number of unconfirmed transactions and the rate of compounding caused consternation amongst the industry regulators, including the Federal Reserve Bank of New York, the Office of the Comptroller of Currency (USA), the Securities and Exchange Commission (USA), the Bank of International Settlements, the United Kingdom Financial Services Authority, the German Financial Supervisory Authority, the Swiss Federal Banking Commission and De Nederlandsche Bank (Holland).

In September 2005, the industry regulators participated in a joint initiative sponsored by the Federal Reserve Bank of New York to address this problem. This resulted in an undertaking being given by the leading market participants in March 2006 an extract of which is provided below:

“The Major Dealers are committed to achieving a stronger steady state position for the industry defined as:
A largely electronic marketplace, where all trades that can be processed electronically through an industry-accepted platform will be processed electronically.
All confirmable trade events (trades, novations, terminations, etc) that can be processed electronically through an industry-accepted platform (“Eligible Trades”) should be processed electronically, through DTCC or any other comparable electronic platform as agreed bilaterally between each Major Dealer and its counterparties (each, an “Electronic Platform”). This Guideline will apply at minimum to clients meeting the volume threshold of four Eligible Trades per month with any one Major Dealer.”

Trading rooms generally divide into two key areas—the “front office” that interacts with the market and the “back office” that records, verifies and confirms the executed transactions. Over time, many of these activities have been automated. The most automated functions are those used to transfer data from the front office to the back office and the onward transfer of data to the general ledger, P&L and cash management. In a majority of participants, the front office uses electronic systems to capture trade data and over 50% of the market uses electronic systems to auto-generate, send and receive confirmation documents.

The least automated functions relate to the digital matching of OTC derivative transactions, either directly (also called bilateral matching) or via an industry-accepted platform (also called clearing house matching). The technical challenges to automated digital matching are complex. Conventionally, this problem has been approached via the use of “Orchestration”.

Orchestration is means of joining together a number of applications via the introduction a centralised control mechanism. This centralised control mechanism provides a means of controlling the way in which each application interacts, and ensures that events execute in a logical sequence.

Orchestration has two weaknesses when applied to this problem set. Firstly, Orchestration relies on a centralised server-based control mechanism to manage the execution of the transaction process. This is not practical in “across the firewall” distributed computer environments. Secondly, the Business Process Execution Language (BPEL) standard, used to describe processes in an Orchestration solution only enables a process to be described from a single viewpoint. This has two impacts, namely monitoring of the overall status of the transaction process is rendered impossible and describing the multiplicity of roles and activities required in a complex transactional environment becomes excessively burdensome.

Using Orchestration to describe the confirmation process for a single set of matched-roles (Alleger and Acceptor) requires programmers to encode the description of the messages to be sent and received separately for each role. This programming effort compounds significantly when multiple roles and activities need to be encoded and compounds exponentially when multiple clearing and matching messaging protocols need to be incorporated within the transaction processing infrastructure.

The requirement of Orchestration to encode the activities separately for each role becomes excessively burdensome when extended to the numerous roles and activities that comprise the processing of complex transactional structures. A sampling of these roles is provided below:
Alleger and Acceptor in the confirmation process
Payer and Payee on coupon payment dates
Receive Fee and Pay Fee on assignments/novations
Assigner, Assignee and Remaining Party on novations
Canceller and Cancellee of a transaction
Modifier and Modification Acceptor of a transaction
Receiver and Deliverer of collateral
Payer and Payee of margins
Payer and Receiver of collateral and/or cash on credit events

The activities that need to be encoded include confirmations, amendments, terminations, partial terminations, novations, allocations, increases, decreases, option exercise, give-ups, corporate actions and transaction exits. This encoding of multiple roles and activities separately is highly complex and results in multiples of man-months of programming effort.

Additional complexity is introduced when changes to the required processes or changes to services communicating with the required processes need to be introduced. This results in a significant maintenance overhead for each messaging protocol. This overhead compounds exponentially when multiple clearing and matching venues are incorporated.

There are now multiple clearing and matching venues available to the market, each with its own messaging protocol, the primary ones being:
ISDA defined protocol for bilateral clearing.
Swapsclear defined protocol for interbank interest rate derivatives clearing via a central clearing house.
DTCC Deriv/SERV defined protocol for credit, equity and interest rate derivatives clearing via a central clearing house.
SwapsWire defined protocol for bi-lateral clearing of credit, interest rate, inflation and equity derivatives.
T-Zero defined protocol for the affirmation of credit derivatives and loan-only default products.
OTCDerivNET defined protocol for interbank cross-currency derivatives clearing via a central clearing house.

Market participants are now faced with the prospect of having to implement multiple messaging protocols and the multiple roles and activities required for each. This presents participants with two difficulties, namely the need to implement the specific protocol for each service and the need to maintain each service protocol.

The implementation of each service protocol using the Orchestration or hand-coded approach is proving to be highly laborious, involving many man-months of programming effort.

Once implemented, the maintenance overhead of each service protocol is also proving to be highly laborious as any introduced changes, either to the protocol itself or the internal services communicating with that protocol need to be extensively re-tested across all the double-encoded processes and the inter-related services to ensure the introduced change has not resulted in any unintended computational consequences.

### SUMMARY OF THE INVENTION

According to a first aspect of the invention, there is provided a method of mediating an exchange of a series of digital messages between parties to ensure compliance with a predetermined messaging protocol associated with a transaction process, the method comprising the steps of:
receiving at a gateway the series of digital messages; and,
validating the digital messages by performing the steps of:
   monitoring the digital messages as they are received at the gateway;
   comparing the messages against the predetermined messaging protocol for the transaction process;
   determining whether the messages comply with or deviate from the predetermined messaging protocol; and,
   generating a notification indicating whether the messages comply with or deviate from the predetermined messaging protocol.

According to a second aspect of the invention, there is provided a intelligent gateway for mediating an exchange of a series of digital messages between parties to ensure compliance with a predetermined messaging protocol associated with a transaction process, the intelligent gateway comprising:
a gateway adapted to receive messages from a first communications network and forward messages to a second communications network, and further adapted to receive messages from the second communications network and forward the messages to the first communications network; and,
a monitor component adapted to monitor the series of messages received by the gateway for compliance with a predetermined messaging protocol and to generate a notification indicating whether the messages comply with or deviate from the predetermined messaging protocol.

According to a third aspect of the invention, there is provided a system for mediating exchanges of series of digital messages between parties to ensure compliance with a predetermined messaging protocol associated with a transaction process, the system comprising a plurality of intelligent gateways according to the second aspect. Preferably, the system comprises a router adapted to route series of messages to different intelligent gateways in dependence on a preferred destination for the messages. The router may also be an intelligent gateway.

The present invention provides continuous monitoring of the processing state across highly distributed systems without introducing a centralised control mechanism. This is achieved by the installation of localised monitoring agents that monitor the actual messages being sent and received by each end-point description. This continuous monitoring enables real-time information to be gathered on the overall behaviour of each transaction process.

This overall transaction monitoring feature enables a user to understand the current state of each transaction process. This is achieved by each localised monitoring agent reporting messaging activity to a correlation engine. This correlation engine consumes the information provided by the monitoring agents and reconstitutes the global status of a transaction process from the information provided. It then compares this re-constituted global status with a “global description”. This comparison enables any deviations from the global description to be immediately identified and managed. In particular, the present invention provides a means of enabling participants in the OTC derivatives market to digitally match their trades across the firewall using the global description of each clearing and matching venues messaging protocol thus enabling participants to monitor transaction status against the global description.

The monitoring of executing events against the global description ensures either the compliant processing of all transaction events or enables deviations from the global description to be immediately identified and captured at the boundary between the internal and external services.

As mentioned, the present invention utilises an unambiguous global description of each of the messaging protocols. The use of WS-CDL enables the described process to be statically checked for unintended computational consequences prior to the deployment of code and changed rapidly without the need for extensive re-testing across inter-related services. Preferably, this is achieved by the use of Web Services Choreography Description Language (WS-CDL) and the Open Source modelling suite provided by the Pi4Technologies Foundation.

The Pi4Technologies Foundation modelling suite enables an unambiguous global description of all processing events for all the messaging protocols to be rapidly generated and presented in a neutral manner, as though a third party was looking at the messaging protocol from an independent viewpoint.

The provision of the unambiguous global description significantly reduces the time required to encode the roles and activities, enables the overall status of each transaction to be monitored, and enables changes to the required processes and/or changes to the services communicating with the required processes to be introduced significantly faster than is achievable via the Orchestration or hand-coded approach.

The present invention also utilises end-point descriptions of the multiple roles. As the invention contains an unambiguous global description of all the message exchanges required for all the roles and activities that comprise the processing of complex transactional structures it becomes possible for a market participant to play multiple roles for different transactions simultaneously. This enables market participants (for instance) to act as Alleger on one trade, whilst playing the role of Payee on another trade and Receiver of Collateral on a third transaction. This increases processing throughput and greatly enhances processing efficiency.

The present invention also enables processing errors to be captured at the boundary between the internal services of the market participant and the external systems with which that participant is communicating. Capturing processing errors at this boundary significantly increases transaction processing efficiency by preventing processing errors from being passed to downstream services.

The present invention provides a method of facilitating the automated digital matching of OTC derivative transactions across multiple clearing and matching venues in a manner that ensures continuous compliance with the required message protocol for each venue by continuously monitoring the overall status of each transaction process.

The invention addresses a key need in the market for an integrated platform that delivers common functionality across multiple clearing and matching venues and provides a single logical point of connectivity across the multiple clearing and matching venues simultaneously.

### BRIEF DESCRIPTION OF THE DRAWINGS

An example of the present invention will now be described in detail with reference to the accompanying figures, in which:

FIG. 1 shows schematically an instance of a ClearGate™ Intelligent Gateway for digital matching;

FIG. 2 shows a ClearGate™ system comprising a router connected to a number of different instances of a ClearGate™ Intelligent Gateway, each implementing a different transaction confirmation protocol;

FIG. 3 shows the ClearGate™ system connected between an IT network of a bank and a number of confirmation venues for trades;

FIG. 4 shows a transaction information service and dashboard which report transactions handled by the ClearGate™ system; and,

FIG. 5 shows an example of a dashboard.

### DETAILED DESCRIPTION

The present invention provides the ability to mediate business messages across multiple intelligent gateways by using business rules. One embodiment of this approach is the routing of confirmation messages across multiple confirmation venues, where communication with each venue is managed by a different intelligent gateway.

The business rules for mediation determine which intelligent gateway a message is sent to and therefore which confirmation venue will process them. One example of such a business rule would be to access the client's records to determine if a contractual agreement has been made regarding where the client's trades are to be confirmed. Another example would be to use information contained within the initial trade confirmation message to identify where the counterparties have explicitly agreed to confirm the transaction. A further example would be to determine whether the message is associated within an existing business transaction, and therefore route the message to the same intelligent gateway that was previously used.

Within the present invention, the intelligent gateway is responsible for ensuring that the messages exchanged with an external organization conform to a set of relevant business scenario rules. Furthermore the intelligent gateway enables failed messages, which have subsequently to be ‘fixed’, to be replayed in order to rectify errors.

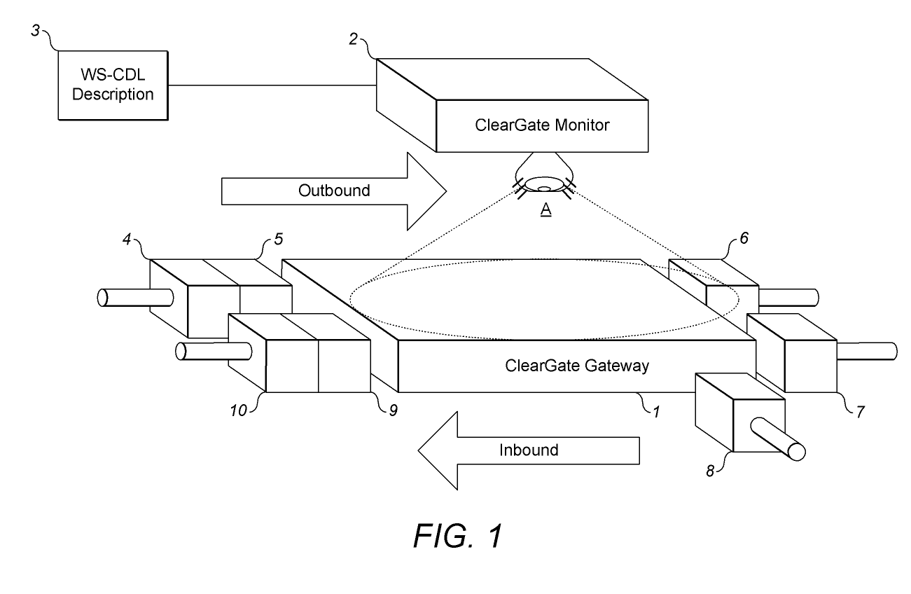

FIG. 1 shows the components in an example of a ClearGate™ Intelligent Gateway in accordance with the present invention. The ClearGate™ Intelligent Gateway comprises two main components, a ClearGate Gateway 1 and a ClearGate Monitor 2, which are decoupled from each other by means of an interface (shown schematically as “A”). The ClearGate Gateway 1 may take the form of a router, but may be implemented as any suitable gateway between two communications networks. The interface (A) represents a set of method calls (or functions) that when implemented a consumer or user of that interface can communicate by means of these method calls (or functions). For example:

public interface Monitor {

public void initialize() throws MonitorException;
public void verifySend(Object message, String messageType,

java.util.List<Identity> ids,
java.util.Properties props) throws MonitorException;

public void verifyReceive(Object message,String messageType,

java.util.List<Identity> ids,
java.util.Properties props) throws MonitorException;

public void close() throws MonitorException;

}

The context for any ClearGate™ instance is as a gateway between some internal network and some external network in which messages are passed from the internal network to the external network for processing and in which responses are received from the external network as a result of processing and then passed into the internal network for internal processing. This could also be vice versa, i.e. messages are received from the external network, processed internally, with the response being sent from internal network to the external network.

The problem that the ClearGate™ system solves is thus the mediation between an internal network and an external network and the adherence of messages exchanged between them against monitoring rules. One embodiment of these monitoring rules would be to monitor the message sequences against a global description language such as WS-CDL (indicated at 3 in FIG. 1). Another embodiment may be to monitor the state associated with the messages against some derivation rules which describe other business scenarios, e.g. an increase on a trade must have a higher nominal value than in the preceding instance of that trade for it to be an increase.

In general the use of interfaces and implementations is an embodiment of an in-process pipeline mechanism enabling one component to use another. We use the term “pipelining” to refer to this technique. This approach provides flexibility in the configuration of inbound/outbound communication adapters and message transformation or schema validation component.

The preferred embodiment of the pipelining technique is synchronous so that when a call pipelines from component A to B to C the return to A from B occurs after C returns to B. The scope of the invention includes asynchronous pipelining techniques.

The exact implementation of “pipeline” components can vary as long as the interface they present remains invariant. Thus an embodiment of the Outbound internal network transportation component 4 could be JMS (Java Messaging Service) such as JBoss or MQSeries and so on. An embodiment of an Outbound transformation component 5 could be XSLT, Java, MetaMatrix, Polarlake and so on.

A message from an internal network is received at the Outbound internal network transportation component 4. This message is received transactionally to avoid data loss in the event of failure. The Outbound internal network component 4 uses an interface provided by the Outbound transformation component 5. The same functionality can be provided by the ClearGate Gateway 1. In this example, the Outbound transformation component 5 (which is optional) that implements the interface used by the Outbound network transportation component 4 enables the outbound message from the internal network to translated to the appropriate outbound format.

When the (optional) Outbound transformation component 5 has finished translating the message received from the internal network into a form suitable for consumption by the external network it invokes an interface on (pipelines to) the ClearGate Gateway 1 which then invokes an interface on (pipelines to) the ClearGate Monitor 2 using the interface (A).

Depending on the exact configuration of the ClearGate™ system it may be in passive mode or active mode. If it is in passive mode, the gateway will not wait for validation of the message by the ClearGate Monitor 2. The result of the validation will only be reported for information purposes, it will not affect the ongoing processing of the message. Therefore the gateway also invokes an interface on an Outbound external network transportation component 6. The Outbound external network transportation component 6 is responsible for sending the transformed message to the desired external organization (i.e. confirmations venue) over an appropriate transport. An embodiment of an Outbound external transportation component 6 may include JBoss, AMQP, MQSeries, SOAP over HTTP and so on.

If the configuration is active rather than passive the ClearGate Gateway 1 may, in the event of any errors, decide not to send the message on to the Outbound external network transport component 6.

In either the passive or the active configuration, the Outbound internal transportation component 4 and the Inbound external network transportation component 7 will invoke a Tracker component 8 after the pipeline they initiate has unwound.

The role of the Tracker component 8 is to capture and inform interested parties of all messages that have been sent from the Outbound internal network transportation component 4 via the optional Outbound transformation component 5 to the Outbound external network transportation component 6 or indeed messages sent from the Inbound external network transportation component 7 via the optional Inbound transformation component 9 to the Inbound internal network transportation component 10.

A preferred embodiment of the Tracker component 8 is the publicly available “com.hattricksoftware.tracker.Tracker” interface which may have one or more specific implementations. This is a Java package that defines the function calls that make up the interface. The embodiment of an interface is some code that has the same function calls but has actual code behind them. The Tracker component 8 implements the interface and so gives it an embodiment as real running code.

After processing a message, the Outbound internal network transportation component 4 is returned a value when the pipeline completes. It may complete successfully or it may not. In the former case, the result is sent by the Outbound internal network transportation component 4 to the Tracker component 8. In the latter, the information returned back through the pipeline will include all of the details of the problem that has occurred and this information, together with the original message, will be sent to the Tracker component 8. Similarly, messages processed by the Inbound external network transportation component 7, that result in either a successful or erroneous outcome, will be reported to the Tracker component 8.

When the ClearGate Gateway 1, as part of a pipeline, invokes the interface (A) on the ClearGate Monitor 2, the ClearGate Monitor 2, using a WS-CDL global description language 3 determines if the message is valid against the description. If it is not valid the message has properties associated to it that show that it is invalid and this is passed back to the ClearGate Gateway 1, which in turn passes the information back to whichever component invoked it as part of the pipeline. Thus the only responsibility that the ClearGate Monitor 2 has is to determine the validity of a message based on a global description.

The ClearGate Monitor 2 is preferably an implementation of the publicly available “com.hattricksoftware.monitor.Monitor” interface which may have one or more specific implementations. This is a Java package that defines function calls that make up the interface. The embodiment of an interface is some code that has the same function calls but has actual code behind them. The ClearGate Monitor 2 implements the interface and so gives it an embodiment as real running code. The current implementation is a wrapper around the pi4soa monitor component but it is not limited in any way to that component. Another embodiment might be to use a RuleML compliant rules engine to achieve the same outcome.

Whilst the use of the ClearGate Monitor 2 in the current embodiment is to validate messages against a global description of the relevant protocol it may also be used to verify other aspects of a business scenario such as semantic rules applied to a message that cannot be implemented either in a global model or in an XML Schema. Thus, the role of the ClearGate Monitor 2 is not confined to a global description of a protocol and the precise message sequencing.

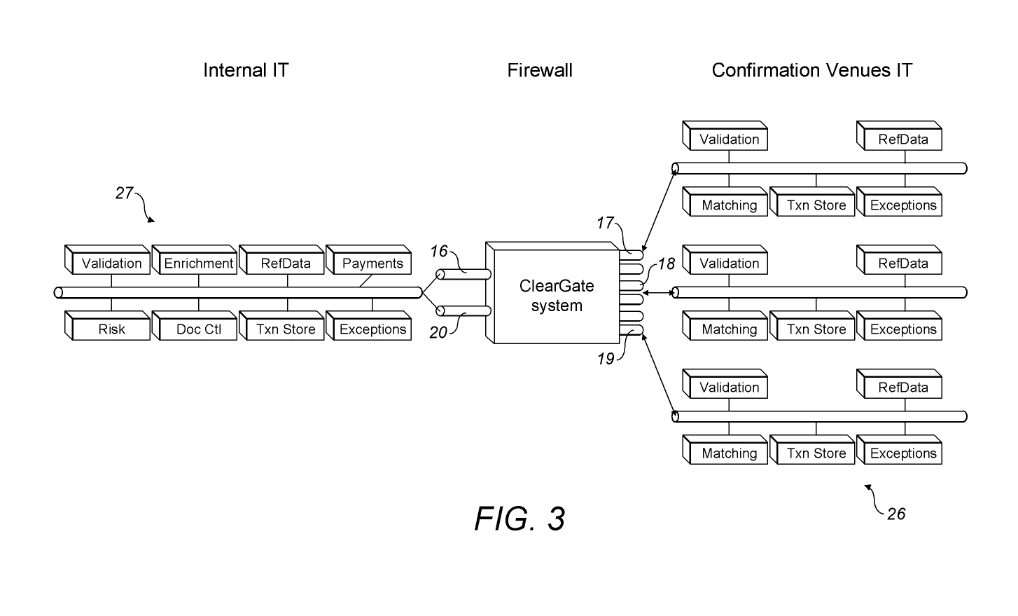

Any responses from a confirmation venue 26 (shown schematically in FIG. 3) are received at an implementation of an Inbound external network transportation component 7. The message is received transactionally to avoid data loss on any failure. The Inbound external network transportation component 7 pipelines through the ClearGate Gateway 1. The ClearGate Gateway 1 pipelines to the ClearGate Monitor 2 which determines the validity of the inbound message against a WS-CDL global description 3.

If the ClearGate™ Intelligent Gateway is in passive mode the inbound message will continue to be pipelined towards an Inbound internal network transportation component 10 through any optional Inbound transformation component 9 regardless of any errors in validity. Any errors in validity are reported back from the ClearGate Monitor 2 through the ClearGate Gateway 1 and back to the Inbound external network transportation component 7. The Inbound external network transportation component 7 reports both successful and erroneous message exchanges back through the Tracker component 8.

If ClearGate™ Intelligent Gateway is in active mode erroneous messages are not pipelined to the Inbound internal network transportation component 10 and are instead reported as the pipeline unwinds to the Tracker component 8 by the Inbound external network transportation component 7.

Both the Inbound external transportation component 7 and the Outbound internal network transportation component 4 maintain all of the connection information required to retry or replay erroneous messages and can be configured to retry automatically in the event of a race condition occurring. Should the number of automatic retries exceed a configurable threshold the message exchange is failed and recorded as an error and reported to the Tracker component 8.

The ability to replay messages is used by the ClearGate™ system to enable errors in messages to be fixed and replayed in situ. In one embodiment, the errors can be examined manually, via the Dashboard 25, corrected and then using the replay information, the message can be resubmitted to the appropriate adapter (either 4 or 7). In another embodiment, pre-configured rules can examine the erroneous message and accompanying information, to determine if it is a common problem that can be fixed without manual intervention. If so, then the replay information can be used to resubmit the fixed message to the appropriate adapter (either 4 or 7).

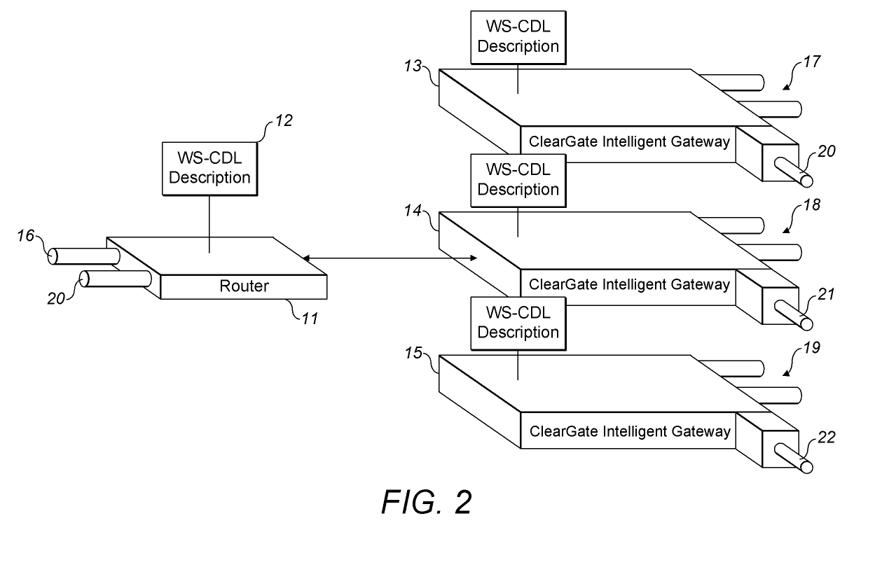

As shown in FIGS. 2 and 3, the ClearGate™ system is typically coupled to the internal IT infrastructure 27 of a bank, for example, via a Rule's-based router 11 (the router 11 has been omitted for clarity in FIG. 3, but is in any case is optional, and only a single instance of a ClearGate™ Intelligent Gateway is shown in this figure). In particular, the ClearGate™ system connects to the internal IT network 27 (via port 16 for outbound and port 20 for inbound messages using JMS) and to the external world of confirmation venues 26 (via ports 17 to 19). The external world of confirmation venues 26 is also JMS based and wrapped to the specific transportation mechanism employed. For DTCC this is using MQSeries, although for others it may be different.

The Router 11 receives messages from the internal IT network 27 in whatever form they arrive through port 20. Based on business rules 12 (for example, scenario rules in RuleML) associated with the Router 11, the Router 11 determines which of the instances 13 to 15 of the ClearGate™ Intelligent Gateway should handle the message.

In this example, one instance of the ClearGate™ Intelligent Gateway 13 handles Deriv/SERV confirmations, another instance 14 handles bi-lateral confirmations, whilst the remaining instance 15 handles SwapsWire confirmations.

The individual instances 13 to 15 of the ClearGate™ Intelligent Gateway continue to provide all of the same active and passive monitoring of messages and mediate between the effective internal network 27 and the processing required at the other end of the external network 26.

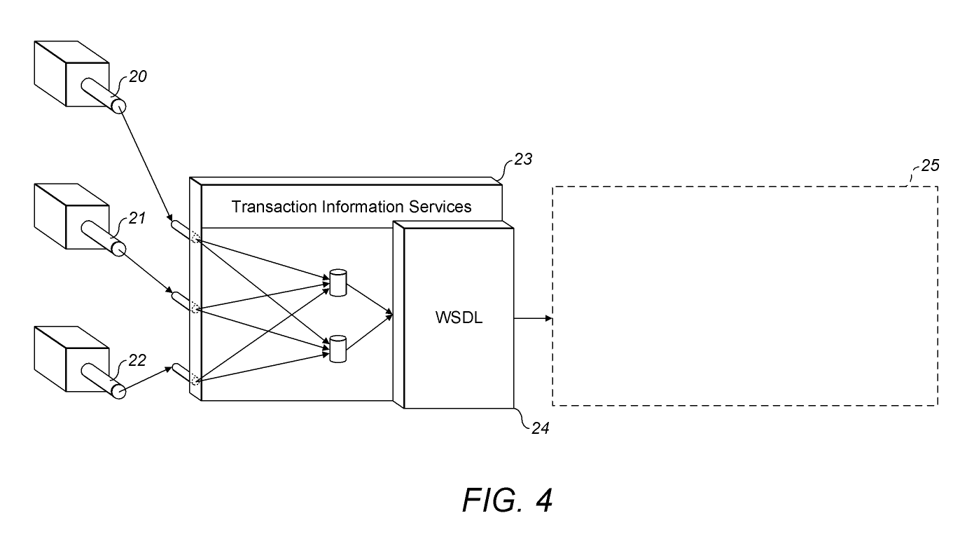

Monitoring information from the respective tracker components 8 of each of the instances 13 to 15 is sent to a Transaction Information Service 23 (see FIG. 4) via ports 20 to 22, respectively.

A further aspect of the present invention is the use of a correlation engine, to reconstitute the monitoring information generated by the tracker components, to create a “global” view of the business transactions being managed by each of the ClearGate Intelligent Gateways. This information would be presented to a user through the Transaction Information Service 23.

The correlation engine operates by matching a ‘sent message’ notification, associated with a particular interaction in the WS-CDL description of the protocol, with the equivalent ‘received message’ notification for the same WS-CDL interaction. These notifications would be generated by different intelligent gateways, representing different communicating roles. Once these matching notifications have been received, the completed ‘interaction’ (i.e. representing the fact that a message was sent by one party and received by another) can be presented to the user.

As shown in FIG. 4, a Transaction Information Service 23 is a set of replicated databases which consume the monitoring information received from the ClearGate™ system and store it. The information is then provided to interested parties using a suitable interface 24 that can be called from a dashboard 25. One embodiment of this interface would be provided using a Web Service with a WSDL interface. Another embodiment may be an interface provided using JMS queues.

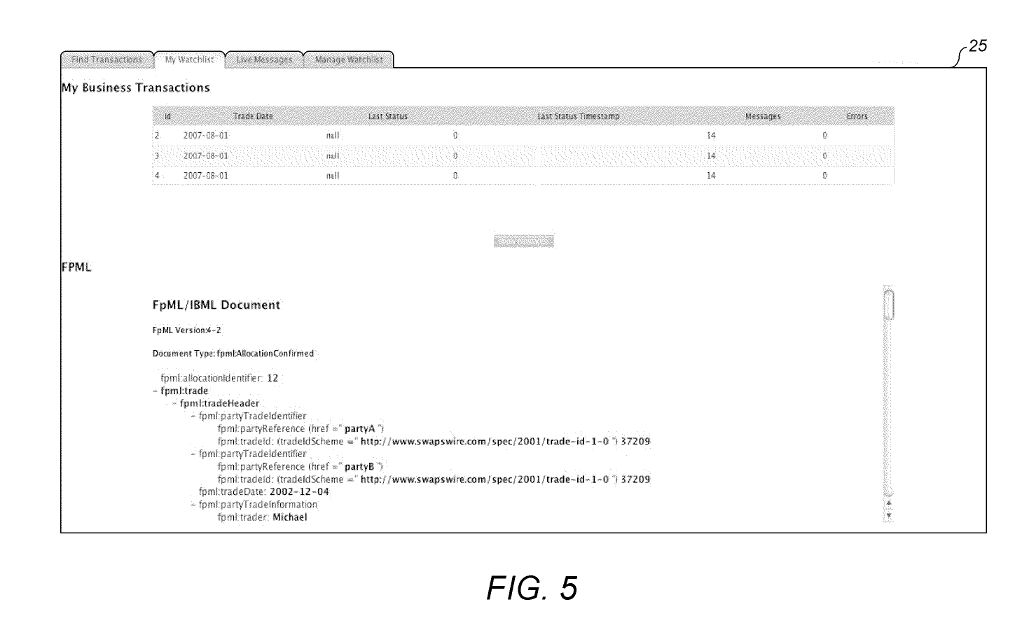

The dashboard 25 reports successful and erroneous transactions, the latter then being handled appropriately and resubmitted. A more detailed view of the dashboard is shown in FIG. 5, where messages relating to particular trades can be identified.

As will be appreciated by those skilled in the art the present invention provides a powerful mechanism for the digital matching of messages between networks and ensuring compliance of the messages with a predetermined messaging protocol. In particular, the protocol is associated with a particular transaction process, such as confirmations and matching. A system of Intelligent Gateways allows for message to be routed through the appropriate gateway, whilst information concerning the messages and their compliance can be tracked and stored centrally and can be correlated to rebuild a global picture of a transaction and individuals roles within it.

1. A method of mediating an exchange of a series of digital messages between parties to ensure compliance with a predetermined messaging protocol associated with a transaction process, the method comprising the steps of:
receiving at a gateway the series of digital messages; and,
validating the digital messages by performing the steps of:
monitoring the digital messages as they are received at the gateway;
comparing the messages against the predetermined messaging protocol for the transaction process;
determining whether the messages comply with or deviate from the predetermined messaging protocol; and,
generating a notification indicating whether the messages comply with or deviate from the predetermined messaging protocol.

2. A method according to claim 1, wherein when the gateway receives a message it invokes a monitor component which performs the step of validating the message.

3. A method according to claim 2, wherein the monitor component stores a computer coded description of the messaging protocol for the transaction process.

4. A method according to claim 3, wherein the description is computer coded in a global description language.

5. A method according to claim 4, wherein the global description language comprises Web Services Choreography Description Language (WS-CDL).

6. A method according to claim 3, wherein the step of validating includes monitoring the sequence of the digital messages and comparing the sequence against the predetermined messaging protocol to determine whether the received messages are part of a valid sequence for the predetermined messaging protocol, and generating a compliance or a non-compliance notification accordingly.

7. A method according to claim 6, further comprising the step of re-ordering the received sequence of digital messages so that they are compliant with the predetermined messaging protocol.

8. A method according to claim 1, wherein the messaging protocol is a confirmations and matching protocol.

9. A method according to claim 1, wherein the step of determining whether the messages comply with or deviate from the predetermined messaging protocol is performed by comparing against a set of derivation rules.

10. A method according to claim 1, further comprising the step of automatically replaying non-compliant messages.

11. A method according to claim 1, further comprising the step of automatically applying rules to correct non-compliant messages.

12. A method according to claim 1, further comprising the step of manually applying rules to correct non-compliant messages.

13. A method according to claim 1, further comprising the step of invoking a tracker component to forward tracker information concerning the messages including the notification indicating whether the messages comply with or deviate from the predetermined messaging protocol.

14. A method according to claim 13, wherein the tracker information includes message replay information.

15. A method according to claim 13, wherein the tracker information is forwarded to a central correlation unit.

16. A method according to claim 15, wherein tracker information from several tracker components is combined in the correlation unit to provide an indication of the overall state of a transaction.

17. A method according to claim 1, further comprising the step of forwarding the messages from the gateway in dependence on the compliance notification.

18. A method according to claim 17, including the step of blocking messages which do not comply with the predetermined messaging protocol from being forwarded by the gateway.

19. A method according to claim 1, carried out over one or more pipelines.

20. A method according to claim 1, further comprising the step of routing the series of messages to the gateway in dependence on a preferred destination for the messages.

21. An intelligent gateway for mediating an exchange of a series of digital messages between parties to ensure compliance with a predetermined messaging protocol associated with a transaction process, the intelligent gateway comprising:
a gateway adapted to receive messages from a first communications network and forward messages to a second communications network, and further adapted to receive messages from the second communications network and forward the messages to the first communications network; and,
a monitor component adapted to monitor the series of messages received by the gateway for compliance with a predetermined messaging protocol and to generate a notification indicating whether the messages comply with or deviate from the predetermined messaging protocol.

22. An intelligent gateway according to claim 21, wherein the gateway is adapted to invoke the monitor component on receipt of a series of messages.

23. An intelligent gateway according to claim 22, wherein the gateway is adapted to invoke an interface of the monitor component.

24. An intelligent gateway according to claim 21, wherein the gateway is adapted to transform messages received from the first communications network into a form suitable for forwarding to the second communications network.

25. An intelligent gateway according to claim 21, wherein the gateway is adapted to transform messages received from the second communications network into a form suitable for forwarding to the first communications network.

26. An intelligent gateway according to claim 21, wherein the gateway comprises a router.

27. An intelligent gateway according to claim 21, comprising one or more pipelines.

28. An intelligent gateway according to claim 21, further comprising a tracker component adapted to forward tracker information including the notification indicating whether the messages comply with or deviate from the predetermined messaging protocol.

29. A system for mediating exchanges of series of digital messages between parties to ensure compliance with a predetermined messaging protocol associated with a transaction process, the system comprising a plurality of intelligent gateways, wherein each intelligent gateway comprises:
a gateway adapted to receive messages from a first communications network and forward messages to a second communications network, and further adapted to receive messages from the second communications network and forward the messages to the first communications network; and,
a monitor component adapted to monitor the series of messages received by the gateway for compliance with a predetermined messaging protocol and to generate a notification indicating whether the messages comply with or deviate from the predetermined messaging protocol.

30. A system according to claim 29, further comprising a router adapted to route series of messages to different intelligent gateways of the plurality in dependence on a preferred destination for the messages.

31. A system according to claim 30, wherein the router is an intelligent gateway which comprises:
a gateway adapted to receive messages from a first communications network and forward messages to a second communications network, and further adapted to receive messages from the second communications network and forward the messages to the first communications network; and,
a monitor component adapted to monitor the series of messages received by the gateway for compliance with a predetermined messaging protocol and to generate a notification indicating whether the messages comply with or deviate from the predetermined messaging protocol.

32. A system according to claim 29, wherein each of the plurality of intelligent gateways comprises a tracker component adapted to forward tracker information including the notification indicating whether the messages comply with or deviate from the predetermined messaging protocol, the system further comprising:
a central correlation unit for correlating information received from the tracker components of the plurality of intelligent gateways.

33. A system according to of claim 29, wherein each of the plurality of intelligent gateways comprises a tracker component adapted to forward tracker information including the notification indicating whether the messages comply with or deviate form the predetermined messaging protocol, the system further comprising:
a dashboard adapted to invoke an interface for viewing message related information received from one or more of the tracker components.
